(19) United States
(12) Patent Application Publication
(10) Pub. No.: US 2014/0359423 A1
(43) Pub. Date: Dec. 4, 2014

(54) LOCAL CACHING TO IMPROVE REMOTE SITE EDITING

(71) Applicant: Microsoft Corporation, Redmond, WA (US)

(72) Inventors: Thao Doan, Redmond, WA (US); Timothy Michael McBride, Snohomish, WA (US); Vinela Pothineni, Redmond, WA (US); Vishal R. Joshi, Redmond, WA (US); David L. A. Anson, Snoqualmie, WA (US); Wai Man (Daniel) Yuen, Bellevue, WA (US)

(21) Appl. No.: 13/908,872

(22) Filed: Jun. 3, 2013

(51) Int. Cl. G06F 17/22

(52) U.S. Cl. CPC G06F 17/2247
USPC 715/234

(57) ABSTRACT

A developer is enabled to select a website for editing. The website is defined by a plurality of files stored at a server. The website files stored at the server include files containing code and may optionally include one or more un-editable files. In response to the developer selecting the website for editing, a call is issued to download a copy of the files containing code from the server to store in a cache at the computing device. The developer is enabled to edit the files containing code to generate an edited version of the website, including being enabled to edit a downloaded copy of a file containing code in the cache when a copy of at least one other file containing code has not yet been downloaded to the cache in response to the call. The developer is enabled to display the edited version of the website.

### BACKGROUND

A website is a set of related webpages served from a single web domain. A website is hosted on at least one web server, and is accessible through a network such as the Internet or a private local area network (LAN) through an Internet address known as a Uniform Resource Identifier (URL) (e.g., a Uniform Resource Locator or URL). All publicly accessible websites collectively constitute the World Wide Web. A webpage of a website is a document, typically written in plain text interspersed with formatting instructions coded in Hypertext Markup Language (HTML). Webpages may be accessed and transported according to Hypertext Transfer Protocol (HTTP). The webpages of a website are typically organized in a hierarchy, with hyperlinking between them (and/or to other websites) to guide the navigation of the website by the user. An application, such as a web browser, may be interacted with by the user to render the content of a webpage for display.

Website development relates to the work involved in developing a website. The complexity of website development has a wide range, encompassing the development of a single page of plain text to the development of web applications, electronic businesses, and social network services that include thousands or millions of webpages and other web objects. A web developer is a programmer who engages in the development of websites. For instance, a web developer may program the code of webpages, scripts, and other programmable web resources that contain code. Furthermore, the web developer may be enabled to edit images, videos, and/or other media.

Typically, a web developer who is going to edit a website hosted on a remote server has to download a copy of all of the website files, along with any dependencies, from the server to the web developer's computer, has to edit the website files locally, and then has to publish the edited website to the remote server. Alternatively, the web developer has to separately download and open each individual remote website file that is going to be edited as he/she proceeds with editing the website.

The first of these two approaches is cumbersome because it has a significant number of steps, and the developer may have to download a large number of website resources to the web developer's computer, including resources of the website that are not even editable by the developer. The second approach has a limitation in performance because the developer has to wait for each separate file to be downloaded prior to editing it, as well as not having access to the non-downloaded files of the website. The second approach is also limited because the website cannot be run locally to preview any changes, and the developer cannot make changes to the website in the context of the surrounding files of the website, which may provide some contextual information.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for enabling a developer to develop a website hosted on a remote server in a more efficient manner. The developer can select a website to edit, and the files of the website are automatically downloaded to the computing device of the developer. Even though all of the files of the website may not have completed being downloaded, the developer may be provided with a complete list of the files of the website, and can select a file in the list to edit. If the selected file has already been downloaded, the developer can begin editing the file. If the selected file has not yet been downloaded, the download of the selected file can be prioritized over the download of other files of the website to enable the developer to be able to edit the selected file sooner. Furthermore, during editing of a webpage, code suggestions may be provided to the developer to enable faster completion of code editing by the developer, as well as contextual information, etc. The code suggestions may be automatically generated based on an analysis of some or all of the downloaded files of the website.

In one implementation, a method in a computing device is provided for enabling a developer to edit a website. A developer is enabled to select a website for editing. The website is defined by a plurality of files stored at one or more servers, including files containing code that are editable, and may include one or more un-editable files. One or more calls are issued to download a copy of the plurality of files from the server to store in a cache at the computing device in response to the developer selecting the website for editing. The developer is enabled to edit the downloaded files containing code, as well as further files of the website, to generate an edited version of the website. The developer is enabled to edit a downloaded copy of a file in the cache when a copy of at least one other file has not yet been downloaded to the cache in response to the call. The developer is enabled to display the edited version of the website locally.

Furthermore, the method may include comparing code input by the developer to an open file in the cache to contents of at least one other file of the plurality of files in the cache to determine one or more code suggestions. The code suggestion(s) may be displayed to the developer. The developer is enabled to select a code suggestion of the displayed code suggestion(s) for inclusion in the open file. Additional types of contextual information may be provided as contextual hints or suggestions, such as the colors used by the website, the images used by the website, etc.

In another implementation, a system in a computing device enables a developer to edit a website. The system includes a website selection module, a website file synchronization module, a website editor, and a website display module. The website selection module is configured to enable a developer to select a website for editing. The website is defined by a plurality of files stored at a server including files containing code, and may include one or more un-editable files. The website file synchronization module is configured to issue a call to download copies of the files containing code from the server to store in a cache at the computing device in response to the developer selecting the website for editing. The website editor is configured to enable the developer to edit the files containing code to generate an edited version of the website. The website editor is configured to display the files containing code in a list at the computing device, to enable the developer to select a file in the list for editing, and to enable the developer to edit a downloaded copy of the selected file in the cache when a copy of at least one other file of the files containing code has not yet been downloaded to the cache in response to the call. The website display module is configured to enable the developer to display the edited version of the website.

Furthermore, when the website file synchronization module determines that the selected file has not yet been downloaded to the cache in response to the call, the website file synchronization module is configured to reorder the download to prioritize downloading of the selected file over downloading one or more other files of the list.

Still further, the website file synchronization module is configured to automatically synchronize the edited files in the cache with the files of the website stored at the server. Furthermore, the website file synchronization module may be configured to automatically synchronize any files of the website at the server that are edited with the files in the cache.

Still further, the system may include a code suggestion module. The code suggestion module is configured to compare code input by the developer to an open file in the cache to contents of at least one other file of the plurality of files in the cache to determine one or more code suggestions, to display the code suggestion(s) to the developer, and to enable the developer to select a code suggestion of the displayed code suggestion(s) for inclusion in the open file. Additional types of contextual information may be provided by the code suggestion module as contextual hints or suggestions, such as suggestions or hints regarding website colors, images, and/or other website features.

A computer readable storage medium is also disclosed herein having computer program instructions stored therein that enable a processor to enable a developer to edit a remotely hosted website according to the embodiments described herein.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of a communication system that enables a developer at a computing device to edit a website stored at a server, according to an example embodiment.

FIG. 2 shows a flowchart providing a process for enabling a developer to edit a website, according to an example embodiment.

FIG. 3 shows a block diagram of a website development system, according to an example embodiment.

FIG. 4 shows a flowchart providing a process for enabling a developer to select a file of a website for editing, according to an example embodiment.

FIG. 5 shows a block diagram of an example website stored at a server and having editable files and optionally un-editable files, according to an example embodiment.

FIG. 6 shows a block diagram of a list displayed to a developer of the editable files of the website of FIG. 5, according to an example embodiment.

FIG. 7 shows a block diagram of the contents of a cache where files of the website of FIG. 5 are in the process of being downloaded, according to an example embodiment.

FIG. 8 shows a flowchart providing a process for prioritizing the download of a selected website file, according to an example embodiment.

FIG. 9 shows a process for synchronizing files of a website undergoing editing by a developer, according to an example embodiment.

FIG. 10 shows a block diagram of a website editor that contains a code suggestion module, according to an example embodiment.

FIG. 11 shows a flowchart providing a process for providing code suggestions to a developer when editing a website file, according to an example embodiment.

FIG. 12 shows a block diagram of an example computing device that may be used to implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments of the present invention are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

A website is a set of related webpages served from a single web domain. A webpage is a document, typically written in plain text interspersed with formatting instructions of Hypertext Markup Language (e.g., HTML, XHTML, etc.). Webpages may be accessed and transported according to the Hypertext Transfer Protocol (HTTP), which may optionally use encryption (e.g., HTTP Secure, HTTPS, etc.) to provide security and privacy for a user of the webpage content. The webpages of a website are typically organized in a hierarchy, with hyperlinking between them (and/or to other websites) to guide the navigation of the website by the user. An application, such as a web browser, may be interacted with by the user to render the content of a webpage for display.

Website development relates to the work involved in developing a website. A website developer (or web developer) is a programmer who engages in the development of a website. A web developer may program the code of webpages, scripts, and other programmable web objects or resources that contain editable code. Examples of programming languages that developers may use for code in webpage files (e.g., webpages, scripts, etc.) of a website include C#, Visual Basic, HTML, CSS (cascading style sheets), JavaScript, PHP, and Node.js, as well as many further programming languages. Furthermore, a developer may be enabled to develop images, video, audio, and/or other media objects for a website.

Typically, a web developer who is going to edit a website hosted on a remote server has to download a local copy of all of the website files, along with any dependencies to the web developer's computer. The web developer edits the downloaded copy of the website files locally, and then publishes the edited website to the remote server. Alternatively, a web developer may separately download and open each individual remote website file for editing as the developer proceeds with editing the website. The first of these two approaches is cumbersome because it has a significant number of steps, and a large number of website resources may end up being downloaded to the web developer's computer, including resources of the website that are not even editable by the developer. The second approach has a limitation in performance because the developer has to wait for each separate file to be downloaded for editing, as well as not having access to the non-downloaded files of the website. The second approach is also limited because the website cannot be run locally to preview any changes, and the developer cannot make changes to the website in the context of the surrounding files of the website, which may provide some contextual information.

Embodiments overcome the deficiencies of these approaches by downloading the editable files of a website to a developer's computing device in a manner that is asynchronous to the developer's ability to edit the files. For instance, in an embodiment, when a developer chooses to edit a remote website in a website development tool or application (also referred to herein as a “website development system”), the application creates a cache on the computing device of the developer (or other storage location that may be accessed more rapidly than the website server) to store the site content. The application requests the remote server for the file structure of the website, including editable and un-editable files of the website. The file structure may optionally be displayed to the developer. In the background, the application asynchronously downloads the remote files of the website that are editable (e.g., breadth first) to the local cache.

The download process may be optimized at the individual file/folder level so that: If the developer selects to open a file which has already been downloaded to the cache, the file is opened immediately for editing. If the developer selects to open a file that has not been downloaded to the cache, the file will be downloaded immediately, and then the download may be resumed for the remaining files/folders.

Embodiments also enable the implementation of rules to include/exclude particular file types that are not editable by the developer (such as images, audio files, videos, etc.) and/or to have infrequently edited files be downloaded last (lowest priority) after frequently edited files are downloaded (highest priority). The ordering of the downloading of files may be arranged in further ways, including ordering the downloading of files by file size, by a frequency of viewing by users (e.g., downloading most frequently viewed files first), etc.

Furthermore, in an embodiment, whenever the developer saves changes to the website, the changes (e.g., the edited files) are pushed to the remote server asynchronously in the background. As such, a cumbersome publish process is not needed. When the developer decides to run the website, all changes are pushed to remote server (if they have not already been pushed to the server), and then the updated remote website may be launched so that the developer can review his/her changes. The developer sees that they are enabled to select a remote website, edit one or more files of the website, and save.

Still further, in an embodiment, because all files that may need to be edited are downloaded to the local cache, the application can use them to provide code suggestions (e.g., intelli-sense) and/or other contextual hints or suggestions for the developer to use to edit the website in the developer's language of choice.

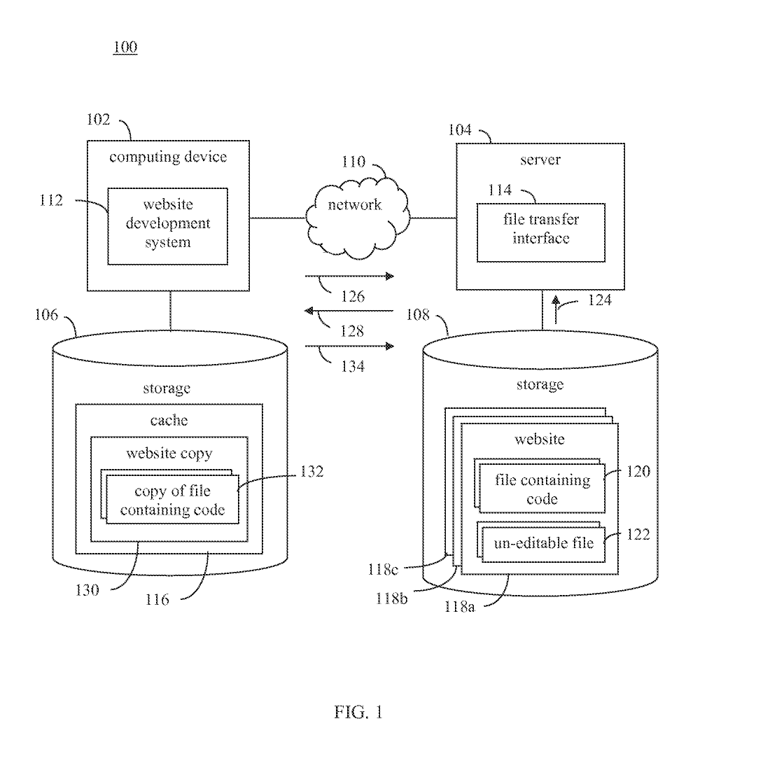

These and further embodiments described herein may be implemented in a variety of environments. For instance, FIG. 1 shows a block diagram of a communication system 100 that enables a developer at a computing device to develop a website stored at a server, according to an example embodiment. As shown in FIG. 1, system 100 includes a computing device 102, a server 104, a first storage 106, and a second storage 108. As further shown in FIG. 1, computing device 102 includes a website development system 112, and server 104 includes a file transfer interface 114. These features of communication system 100 are described as follows.

Computing device 102 may be any type of stationary or mobile computing device, including a desktop computer (e.g., a personal computer, etc.), a mobile computer or computing device (e.g., a Microsoft® Surface® device, a personal digital assistant (PDA), a laptop computer, a notebook computer, a tablet computer such as an Apple iPad™, a netbook, etc.), a mobile phone (e.g., a cell phone, a smart phone such as a Microsoft Windows® phone, an Apple iPhone, a phone implementing the Google Android™ operating system, a Palm® device, a RIM Blackberry® device, etc.), or other type of mobile device. Server 104 may be implemented in one or more computer systems, including one or more servers which may be any type of computing devices described herein or otherwise known that is/are capable of enabling the corresponding functionality described herein.

Each of storage 106 and storage 108 may include one or more of any type of storage mechanism to store website files and folders, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

Computing device 102 and server 104 are communicatively coupled by network 110. Network 110 may include one or more communication links and/or communication networks, such as a PAN (personal area network), a LAN (local area network), a WAN (wide area network), or a combination of networks, such as the Internet. Computing device 102 and server 104 may be communicatively coupled to network 110 using various links, including wired and/or wireless links, such as IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB links, etc.

Computing device 102 is associated with a corresponding user (a developer) that interacts with the respective computing device as described herein. Computing device 102 is a computing device that may be special purpose or may be used by associated persons for any number and type of functions. Computing device 102 is shown in FIG. 1 for purposes of illustration. Any number of computing devices may be present in system 100, including tens, hundreds, thousands, and even greater numbers of computing devices. Each computing device may operate a corresponding website development system that enables editing of websites stored at server 104. For instance, website development system 112 may be a proprietary or commercially available website development application, tool, or suite, such as Microsoft® Visual Studio®, developed by Microsoft Corporation of Redmond, Wash., JDeveloper® supplied by Oracle Corporation of Redwood City, Calif., ActiveState® Komodo® provided by ActiveState Software Inc. of Vancouver, British Columbia, and Eclipse IDE provided by Eclipse Foundation.

As shown in FIG. 1, storage 108 is coupled to server 104. Storage 108 may be directly connected to server 104, or may be coupled to server 104 through network 110. Storage 108 stores websites, including first-third websites 118a-118c. Websites 118a-118c are stored in storage 108 in the form of files (and optionally folders) that define the corresponding websites. Each website may include files that are editable by a developer and may include files that are not editable by a developer. For instance, as shown in FIG. 1, website 118a includes one or more files containing code (including a file containing code 120), and may include one or more un-editable files (such as an un-editable file 122). Editable files include program code that may be edited by a developer (e.g., HTML webpages, scripts, etc.). Un-editable files are objects or resources that do not include program code that is editable by a developer, such as image files, video files, audio files, PDF documents, etc.

A developer at computing device 102 may desire to edit a website maintained by server 104 in storage 108. For instance, as shown in FIG. 1, the developer may interact with website development system 112 to select one of websites 118a-118c for editing. Website development system 112 may transmit a website request 126 from computing device 102 through network 110 to file transfer interface 114 at server 104. Website request 126 identifies a website selected for editing, and may be transmitted through network 110 according to any communication standard and/or protocol (e.g., TCP/IP (Transmission Control Protocol/Internet Protocol), User Datagram Protocol (UDP), a suitable file transfer protocol such as FTP (File Transfer Protocol), HTTP (Hypertext Transfer Protocol), etc.). In response, a copy of the selected website may be retrieved from storage 108 as requested website copy 124, and file transfer interface 114 may transmit a requested website file stream 128 from server 104 through network 110 to website development system 112 at computing device 102. Requested website file stream 128 includes files and other information of requested website copy 124. For instance, requested website file stream 128 may include a list of the files of the selected website that is initially transmitted to website development system 112, and may further include copies of the files of the requested website that are subsequently transmitted in requested website file stream 128.

As shown in FIG. 1, a website copy 130 is stored in a cache 116 in storage 106 by website development system 112. Website copy 130 includes a copy of the files of the selected website transmitted in requested website file stream 128. Cache 116 is a storage location (e.g., a folder) established to store website copy 130. Website file stream 128 may be transmitted according to any communication standard and/or protocol, and files may be transmitted in website file stream 128 in a serial or a parallel fashion. As each file is received (e.g., downloaded) in requested website file stream 128, the received file is stored in cache 116. The developer that requested the website for editing may interact with website development system 112 to edit website copy 130. In one embodiment, only the editable files of the selected website (files containing code) are transmitted in requested website file stream 128. Thus, as shown in FIG. 1, in an embodiment, website copy 130 may include copies of the files containing code of the selected website, such as copy of file containing code 132, which is a copy of file containing code 120 at server 104. However, website copy 130 may not include copies of un-editable files of the selected website, such as un-editable file 122. This is because the un-editable files are not editable by the developer, and thus they are not needed.

After the developer edits one or more files of website copy 130, the edited file(s) may be transmitted back to server 104 to be stored in the original website files. For instance, as shown in FIG. 1, website development system 112 may transmit edited file(s) 134 from computing device 102 through network 110 to file transfer interface 114 at server 104. Edited file(s) 134 includes one or more edited files of website copy 130, and may be transmitted through network 110 according to any communication standard and/or protocol. It is noted that as each file is edited (and saved), the file may be separately transmitted in edited file(s) 134, or edited file(s) 134 may include a group of edited files of website copy 130 that are transmitted together (e.g., when the developer exits website development system 112, when the developer executes a synchronization function, and/or at other time). File transfer interface 114 receives edited file(s) 134 and replaces the corresponding file(s) of the selected website in storage 108 with edited file(s) 134. For instance, copy of file containing code 132 may be received in edited file(s) 134, and file transfer interface 114 may replace file containing code 120 with copy of file containing code 132 in website 118a.

In this manner, in communication system 100, a developer may be enabled to edit a website that is stored remotely, in an efficient manner Elements of communication system 100 shown in FIG. 1 may be configured in various ways, in embodiments. Example embodiments for website development system 112 and further elements of communication system 100 are described in the following subsections.

A. Example Embodiments for a Enabling a Developer to Edit a Website

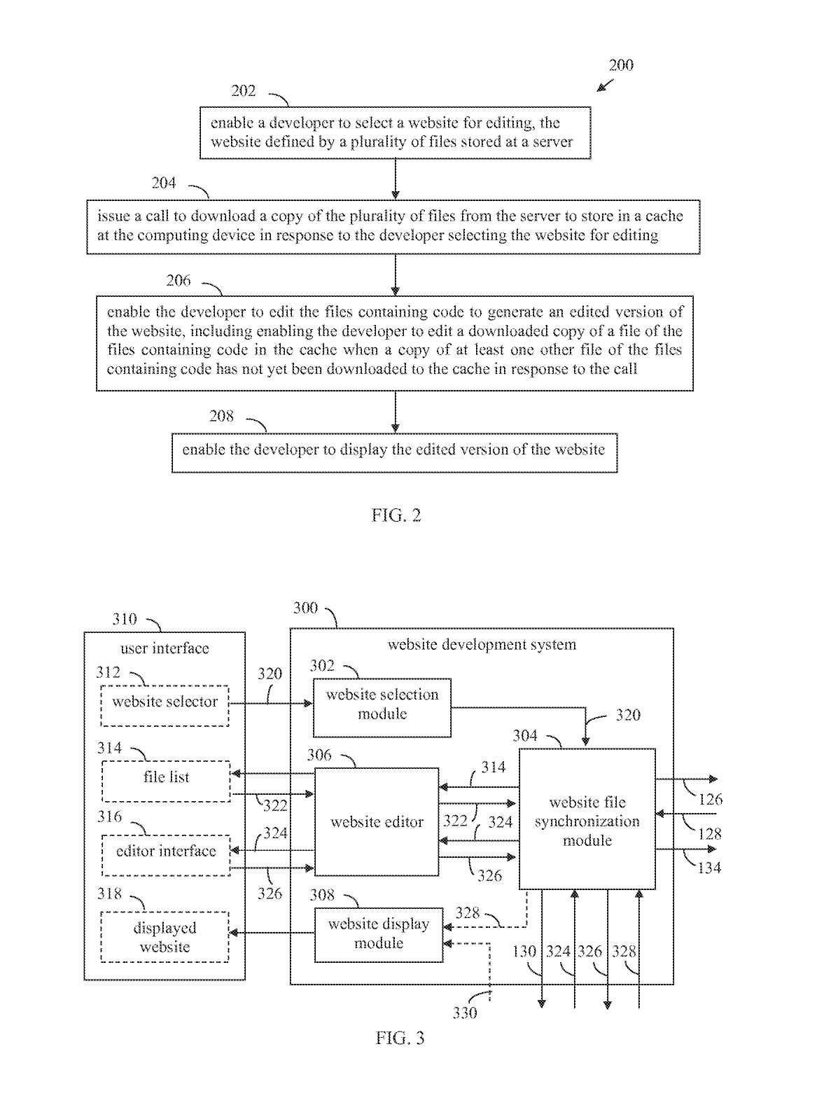

Website development system 112 of FIG. 1 can be configured in various ways to enable developers to edit websites according to the techniques described herein. For instance, FIG. 2 shows a flowchart 200 providing a process for enabling a developer to develop a website, according to an example embodiment. Website development system 112 of FIG. 1 may operate according to flowchart 200, in an embodiment. For purposes of illustration, flowchart 200 of FIG. 2 is described with respect to FIG. 3. FIG. 3 shows a block diagram of a website development system 300, according to an example embodiment. Website development system 300 is an example of website development system 112. As shown in FIG. 3, website development system 300 includes a website selection module 302, a website file synchronization module 304, a website editor 306, and a website display module 308. Flowchart 200 and website development system 300 of FIG. 3 are described as follows. Further structural and operational embodiments will be apparent to persons skilled in the relevant art(s) based on the following description.

Flowchart 200 begins with step 202. In step 202, a developer is enabled to select a website for editing, the website defined by a plurality of files stored at a server. For example, referring to FIG. 3, website development system 300 may generate a user interface 310 that enables a developer to interact with website development system 300 to edit a website. User interface 310 may be a text input interface, a graphical user interface (GUI), and/or other user interface type. User interface 310 may include any number and combination of user interface elements or controls to enable the developer to select, edit, display, save, and/or otherwise interact with a website. Examples of such user interface elements/controls include text entry boxes, graphical icons, visual indicators, menus, radio buttons, check boxes, sliders, etc. It is noted that user interface 310 may display features described herein (e.g., website selector 312, file list 314, editor interface 316, etc.) in a same window or frame simultaneously, or may display these or other features described herein in multiple different windows or frames.

In FIG. 3, a developer may be enabled to interact with user interface 310 to select a website for editing, such as by interacting with a website selector 312 that is provided by (e.g., displayed by) user interface 310. Website selector 312 may be any type of user interface element or control described herein or otherwise known (e.g., a navigator that enables display of a list of websites accessible to the developer at server 104 of FIG. 1, etc.). The developer may need to provide a user identifier, a password, and/or other identification and/or authorization information to provide to file transfer interface 114 (FIG. 1) to be enabled to select and edit a particular website. As shown in FIG. 1, websites, such as website 118a in storage 108, are defined by a plurality of files including one or more files containing code and optionally one or more un-editable files. As shown in FIG. 3, website selection module 302 receives a selected website indication 320 from website selector 312 that was input by the developer, and provides selected website indication 320 to website file synchronization module 304.

Referring back to FIG. 2, in step 204, a call is issued to download a copy of the plurality of files from the server to store in a cache at the computing device in response to the developer selecting the website for editing. For example, as shown in FIG. 3, website file synchronization module 304 may transmit website request 126 to file transfer interface 114 at server 104 (FIG. 1). Website request 126 is a call to download a copy of the files the make up the website indicated in selected website indication 320 from server 104. Website request 126 may include the identification and/or authorization information described above. If file transfer interface 114 determines that the developer is authorized to access the selected website, file transfer interface 114 transmits requested website file stream 128 in response to website request 126. As shown in FIG. 3, requested website file stream 128 is received by website file synchronization module 304. Requested website file stream 128 includes files and other information of the selected website from storage 108. As described above, requested website file stream 128 may initially include a list of the files of the selected website. Furthermore, requested website file stream 128 includes the files of the selected website. As each file is received (e.g., downloaded) in requested website file stream 128, website file synchronization module 304 stores the received file in cache 116. For instance, as shown in FIG. 3, website file synchronization module 304 stores website copy 130 in cache 116 (FIG. 1).

In step 206, the developer is enabled to edit the files containing code to generate an edited version of the website, including enabling the developer to edit a downloaded copy of a file of the files containing code in the cache when a copy of at least one other file of the files containing code has not yet been downloaded to the cache in response to the call. In an embodiment, website editor 306 of FIG. 3 is configured to enable the developer to edit the copies of the files of the website that have been stored in cache 116 (FIG. 1). For instance, as shown in FIG. 3, website editor 306 may generate an editor interface 316 that a developer can interact with to edit a selected website file. Editor interface 316 may include any one or more user interface elements or controls described herein or otherwise known to enable a developer edit a website file, and save the edited website file to cache 116.

For example, as shown in FIG. 3, website editor 306 may receive a selected website file 324 for editing from cache 116 (FIG. 1) through website file synchronization module 304. Website editor 306 may display a portion or entirety of the selected website file 324 in editor interface 316 for editing by the developer. When the developer has saved the edited file, or at other predetermined time (e.g., automatic saves that occur periodically, etc.), website editor 306 may provide the edited version of selected website file 324 to website file synchronization module 304 as edited website file 326. Website file synchronization module 304 may store edited website file 326 in cache 116 as a replacement of selected website file 324.

Website editor 306 may enable the developer to select any one or more of the downloaded file copies for editing in any manner. Furthermore, the developer may be enabled to edit one or more of the website file copies even if all of the copies of the files of the website have not yet been downloaded to cache 116.

For instance, in an embodiment, the list of the files of the selected website received from the server may be displayed to the developer by website editor 306, even while the files of the selected website have not completed being downloaded into cache 116. The developer may be enabled to select a website file for editing from the list. This saves the developer time by not having to wait until all website files are downloaded before the developer can begin editing the website.

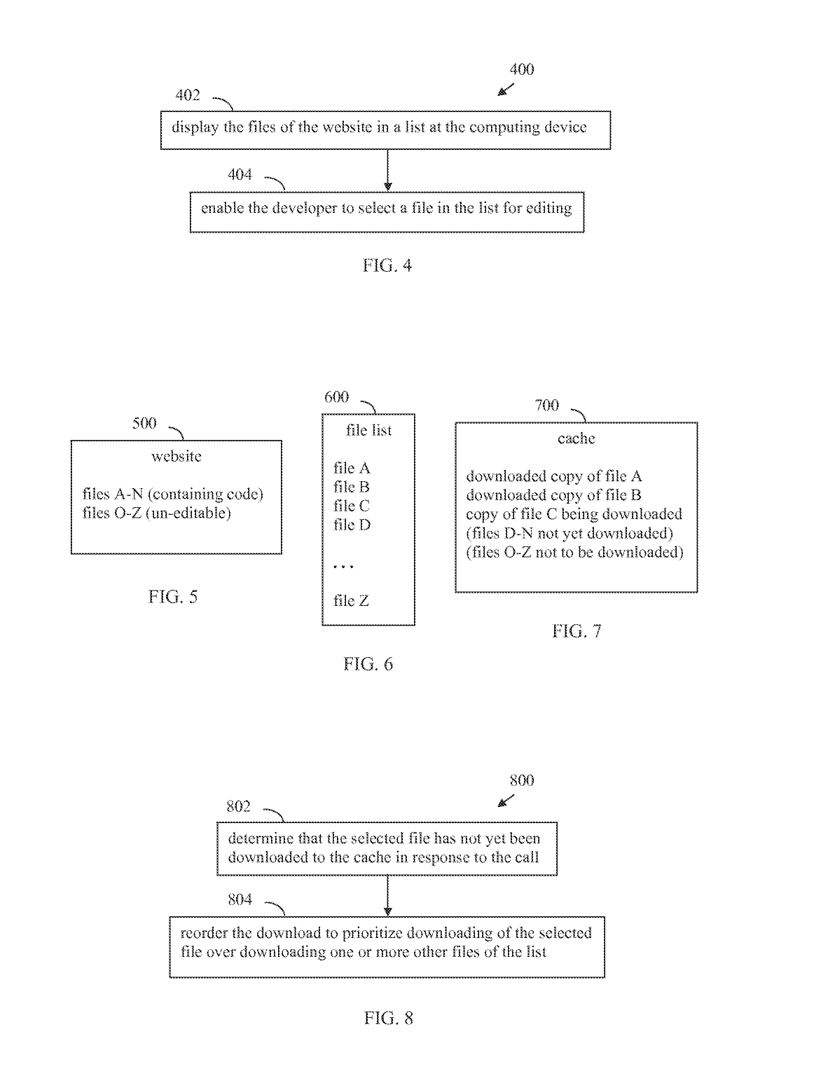

For example, FIG. 4 shows a flowchart 400 providing a process for enabling a developer to select a file of a website for editing, according to an embodiment. In an embodiment, website development system 300 may be configured to perform flowchart 400. Flowchart 400 is described as follows.

In step 402 of flowchart 400, the files of the website are displayed in a list at the computing device. For example, as shown in FIG. 3, website file synchronization module 304 may provide a file list 314 to website editor 306 that was received in requested website file stream 128. In an embodiment, file list 314 lists the files containing code of the selected website as well as other files of the website (e.g., may optionally also list the un-editable files). Website editor 306 may display file list 314 in user interface 310.

In step 404, the developer is enabled to select a file in the list for editing. In an embodiment, website editor 306 displays file list 314 as a list of file names that are selectable. The developer may interact with file list 314 to select a displayed file name for editing in any manner. For instance, the developer may select a file name in file list 314 with a mouse click, by interacting with a keyboard (e.g., using arrow keys to highlight the file name, and selecting the “Enter” key), by touch screen touch, by gesture, by voice command, by eye movement, etc.

For instance, FIG. 5 shows a block diagram of an example website 500 stored at a server and having editable and un-editable files, according to an example embodiment. As shown in FIG. 5, example website 500 includes files A-N, which contain code and are editable, and files O-Z, which are un-editable files. If a developer selects website 500 for editing (in step 202 of FIG. 2), website file synchronization module 304 of FIG. 3 may receive requested website file stream 128 that includes a list of the files of website 500 and copies of the files of the website 500. In an embodiment, copies of files A-N, which contain code, may be included in requested website file stream 128, while files O-Z, which are un-editable, are not included in requested website file stream 128. As such, while file list 314 displayed in FIG. 3 may include files A-Z, files A-N may be downloaded in requested website file stream 128, but not files O-Z (because they are not editable). For instance, FIG. 6 shows a file list 600 that may be displayed to the developer for website 500 in user interface 310 (FIG. 3), according to an example embodiment. As shown in FIG. 6, file list 600 includes all files A-Z of the website, including editable files A-N and un-editable files O-Z. In this manner, the developer can view a full list of the files of website 500. However, because files O-Z are not editable, the developer may be enabled only to select files A-N in file list 600 for editing, even though files O-Z are also displayed. In another embodiment, file list 600 may include editable files A-N, but not un-editable files O-Z. In such case, the developer may select any of files A-N for editing.

It is noted that in some cases, when the developer selects a file from a displayed file list, the file may have already been downloaded to cache 116. In such case, the developer may be enabled by website editor 306 to edit the selected file immediately. In another case, the developer may select a file from the displayed file list for editing that has not yet been downloaded to cache 116. In such case, website file synchronization module 304 may expedite the downloading of the selected file to cache 116 so that the developer may begin editing the file.

For instance, FIG. 7 shows a block diagram of the contents of a cache 700 where files of website 500 of FIG. 5 are in the process of being downloaded, according to an example embodiment. As shown in FIG. 7, at a particular time, a copy of files A and B may be downloaded to cache 700, a copy of file C may be in the process of being downloaded to cache 700, and copies of files D-N may not have been downloaded to cache 700 yet (copies of un-editable files O-Z are not to be downloaded). As such, in this example, if the developer selects one of files A or B for editing in file list 600, website editor 306 can retrieve the copy of the selected file from cache 700 to be edited immediately. However, if the developer selects one of files C-N in file list 600, the developer has to wait for the selected file to be downloaded to cache 700 before the file can be edited. In such case, if the selected file was file C, the developer can wait until the copy of file C is finished being downloaded before being enabled to edit the file. When one of files D-N is selected for editing by the developer, website file synchronization module 304 may expedite the downloading of the selected file to cache 116 by reordering the downloading of the website files.

For instance, FIG. 8 shows a flowchart 800 providing a process for prioritizing the download of a selected website file, according to an example embodiment. In an embodiment, website file synchronization module 304 may be configured to perform flowchart 800. Flowchart 800 is described as follows.

In step 802 of flowchart 800, the selected file is determined to not yet have been downloaded to the cache in response to the call. In an embodiment, a developer may interact with file list 314 shown in FIG. 3 to select a file of the website for editing by website editor 306. As shown in FIG. 3, website editor 306 may receive a selected file indication 322, and may provide selected file indication 322 to website file synchronization module 304. Website file synchronization module 304 may determine that the selected file indicated by selected file indication 322 has not yet been downloaded to cache 116.

In step 804, the download is reordered to prioritize downloading of the selected file over downloading one or more other files of the list. In response to determining that the selected file has not yet been downloaded, website file synchronization module 304 may be configured to reorder the downloading of files of the website in requested website file stream 128 from the server to prioritize the selected file over other files. Website file synchronization module 304 may generate an updated ordering of downloading the files, and may transmit this updated ordering to file transfer interface 114 at the server to cause file transfer interface 114 to transmit the files of the website according to the updated order. In this manner, the selected file may be received sooner for editing.

For instance, in the example of FIG. 7, an original order of downloading of the files of the website may be the order of file A, file B, file C, . . . file N (alphabetical order). If the selected file for editing is file F, and files A and B have already been downloaded, the downloading of file C may be optionally discontinued, and file F may be downloaded prior to downloading files C-E. In this manner, the file download may be reordered to occur in the order of file A, file B, file F, file C, file D, file E, files G-N. Alternatively, the file download may be reordered to occur in a different order such that file F is downloaded sooner than in the original order (e.g., the downloading of file C may be completed, and then file F may be downloaded next, etc.).

Note in an embodiment, as copies of files are edited in cache 116 (FIG. 1) by website editor 306, the edited file copies may be synchronized with the website files stored at the server (e.g., in storage 108 of FIG. 1). For instance, FIG. 9 shows a step 902 that may be performed to synchronize files of a website undergoing editing by a developer, according to an example embodiment. In an embodiment, step 902 may be performed by website file synchronization module 304 of FIG. 3. Step 902 is described as follows.

In step 902, the edited one or more files in the cache are automatically synchronized with the plurality of files stored at the server. For instance, website file synchronization module 304 of FIG. 3 may be configured to automatically synchronize edited website files. As described above, as website files are edited, website file synchronization module 304 may store the edited website files (e.g., edited website file 326) in cache 116 (FIG. 1). Additionally, website file synchronization module 304 may be configured to transmit the edited website files to the server to replace the original website files. Website file synchronization module 304 may transmit an edited website file to the server as the file is edited (and saved) in edited file(s) 134, such that each edited website file is separately synchronized, or website file synchronization module 304 may transmit multiple edited files together in edited file(s) 134 (e.g., when the developer exits website development system 300, when the developer executes a synchronization function, and/or at other time). As described above, file transfer interface 114 shown in FIG. 1 may receive edited file(s) 134 and replace the corresponding file(s) of the selected website in storage 108 with edited file(s) 134. For instance, copy of file containing code 132 may be transmitted to server 104 in edited file(s) 134, and file transfer interface 114 may replace file containing code 120 in storage 108 with copy of file containing code 132 in website 118a.

Thus, file/folder operations (e.g., delete, add new, rename, save) may be performed in a non-blocking fashion, such that they occur in the background while the developer proceeds with their editing without having to wait for each change to be pushed to the remote server. In an embodiment, website synchronization module 304 may check with the server to determine whether any of the files at the server have been changed since the website files were downloaded so that website files that were changed at the server (e.g., by a second developer editing the website) are not overwritten.

Furthermore, by interacting with editor interface 316, by executing a “drag-and-drop” or other file copy or move function, and/or in other manner, one or more new website files may be added by the developer to the website. Any new website files may be stored in cache 116 by website file synchronization module 304, and may be synchronized with the server to be stored with the website files of the website at the server (e.g., an additional file containing code may generated at website development system 300, and may be added to website 118a stored in storage 108, as shown in FIG. 1). The new website files may be displayed by website editor 306 in file list 314. Likewise, website files may be deleted by interacting with editor interface 316. The deletion of a website file in cache 116 may be synchronized with the server by website file synchronization module 304, such that the deleted file is removed from the website stored in storage 108. Furthermore, the deleted file may be removed from file list 314 by website editor 306.

Referring back to FIG. 2, in step 208, the developer is enabled to display the edited version of the website. In an embodiment, website display module 308 may be configured to enable a developer to display an edited version of the website. In this manner, the developer can view the edits the developer has made to the website in a live fashion. For instance, as shown in FIG. 3, website display module 308 may show the website as displayed website 318 in user interface 310. Website display module 308 may include a web browser or may access a web browser to display the website. Examples of suitable web browsers include Internet Explorer®, developed by Microsoft Corp., Mozilla Firefox®, developed by Mozilla Corp. of Mountain View, Calif., Safari®, developed by Apple Inc., and Google® Chrome. To receive the files of the website for display, website display module 308 may access the files of the website in cache 116 as website files 328 (e.g., through website synchronization module 304). Alternatively, website display module 308 may receive the files of the website from the server (e.g., as website files 330, which may be files of website 118a received from server 104 in FIG. 1).

Note that prior to enabling the website to be displayed, website display module 308 may cause website editor 306 to save all files being edited to cache 116, and may cause website synchronization module 304 to synchronize the edited website files with the server. In this manner, the latest version of the edited website may be displayed.

It is noted that after the developer closes editing of the website (e.g., closes website development system 300), cache 116 may maintain the copies of the website files. In this manner, the next time the developer decides to edit the website using website development system 300, the website files are already present in cache 116, and therefore do not need to be re-downloaded (a check may be performed with the server to make sure any files that were changed at the server relative to the copies stored in cache 116 are copied to cache 116).

B. Example Embodiments for Assisting a Developer in Editing a Website

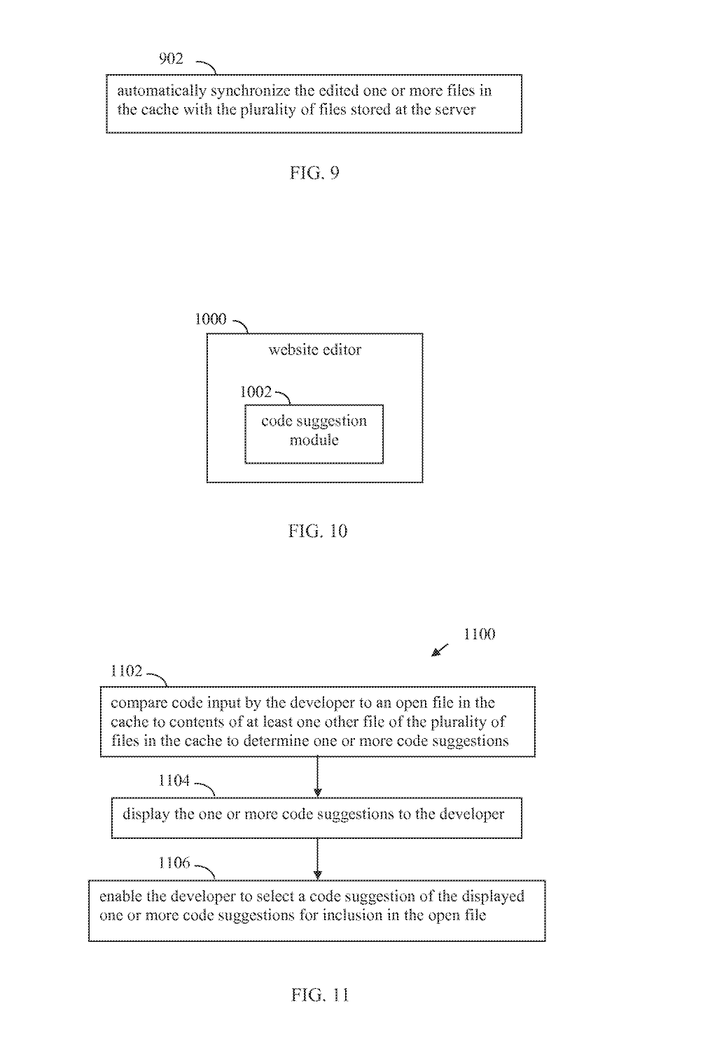

As described above, in embodiments, because all files that may need to be edited are downloaded to the local cache, a website development system can use the local files to generate code suggestions (e.g., intelli-sense) to assist the developer in editing the website files. For instance, FIG. 10 shows a block diagram of a website editor 1000 that contains a code suggestion module 1002, according to an example embodiment. Website editor 1000 is an example of website editor 306 in FIG. 3. Code suggestion module 1002 is configured to provide completions and/or further types of code suggestions to the developer when entering code into a file, to aid the developer in generating code.

For instance, code suggestion module 1002 may provide assistance to developers writing code by presenting lists of possible code “completions” and optionally documentation for those completions, based on a current cursor position within a website file. The presentation of automatically determined code completions is called “autocompletion.” In Microsoft® Visual Studio®, autocompletion is implemented by functionality referred to as IntelliSense®. According to autocompletion, such as is performed by IntelliSense®, marker characters typed in by a programmer are looked for, such as periods, or other separator characters (depending on the programming language). After the programmer types in one of these marker characters immediately after the name of a term having one or more further selectable code completions, a pre-determined, pop-up list of suggested code completions is presented. The list of suggested code completions for a particular website file may be generated by code suggestion module 1002 by analyzing the contents of all of the files of the website stored in cache 116 (FIG. 1). The developer may select a suggested code completion from the list to be automatically entered into the code of the file. The suggested code completion may finish a line of code for the developer, may provide multiple lines code, and/or may provide code in another form. Thus, in embodiments, code suggestion module 1002 may be configured to implement autocompletion, IntelliSense®, and/or other form of code suggestion generation.

For instance, in an embodiment, code suggestion module 1002 may operate as shown in FIG. 11. FIG. 11 shows a flowchart 1100 providing a process for providing code suggestions to a developer when editing a website file, according to an example embodiment. Flowchart 1100 is described as follows:

In step 1102, code input by the developer to an open file in the cache is compared to contents of at least one other file of the plurality of files in the cache to determine one or more code suggestions. In an embodiment, code suggestion module 1002 may compare code (e.g., text) that the developer inputs to a website file that is open for editing by website editor 1000 to the contents of one or more others of the website files in cache 116 (as well as to other portions of the contents of the open website file itself). The input code portion may be a few characters of code, one or more words of code, or other portions of code. Code suggestion module 1002 may be configured to compare the code portion to the actual contents of the other website files, and/or to pattern signatures generated based on the other website files. For instance, a function X included in the code portion may be compared to the contents of the other files and/or to one or more pattern signatures to determine whether function X is present elsewhere and/or is a pattern signature. If one or more matches is/are found (e.g., an exact match, a match of over a predetermined percentage of code, etc.), code suggestion module 1002 may retrieve one or more code suggestions from a knowledge set repository corresponding to the one or more matching code portions.

Code suggestion module 1002 may perform various forms of analysis when comparing input code to other code and/or pattern signatures to determine whether there are any matches. For instance, in embodiments, code suggestion module 1002 may perform a string comparison (e.g., comparing code letter by letter, etc.), may analyze the text, analyze a language syntax tree, may analyze architectural layering, may analyze information provided by a compiler about semantic meaning, may analyze tracked information as the developer was writing the code to see the form/order/style/timing in which the developer wrote the code to extract corresponding meaning, etc.

In step 1104, the one or more code suggestions are displayed to the developer. As described above, website editor 306 may present the one or more code suggestions in editor interface 316 to the developer to enable the developer to select a code suggestion to be entered into the open website file if desired. The code suggestion(s) may be displayed by website editor 306 in association with the input code, such as in the form of a popup list, or in another form.

In step 1106, the developer is enabled to select a code suggestion of the displayed one or more code suggestions for inclusion in the open file. In an embodiment, a developer can view and select one of the selectable code suggestions displayed by website editor 306, if desired, to be entered into the open website file. The code suggestion may be selected by the developer in any suitable manner, such as by using a mouse click, a key combination, a gesture applied to a touch screen or other gesture interface, voice, etc., to be inserted into the open website file.

Note that further types of assistance in editing website code are enabled in embodiments. For instance, in an embodiment, website editor 306 may be configured to enable the developer to perform a “find all” function when editing a website file. The “find all” function may search for the presence of a search term input by the developer in all of the website files stored in cache 116 (e.g., the files containing code of the website). In this manner, the developer may be enabled to more easily find occurrences of code terms of interest (e.g., classes, variables, other text, etc.) within the website. Furthermore, using the “find all” function, the developer may also be enabled to perform a “replace all” function, where multiple occurrences of a particular code term can be replaced with a desired replacement code term in all of the files of the website in cache 116.

D. Example Computing Device and Server Embodiments

Website development system 112, file transfer interface 114, website development system 300, website selection module 302, website file synchronization module 304, website editor 306, website display module 308, website editor 1000, code suggestion module 1002, flowchart 200, flowchart 400, flowchart 800, step 902, and flowchart 1100 may be implemented in hardware, or hardware combined with software and/or firmware. For example, website development system 112, file transfer interface 114, website development system 300, website selection module 302, website file synchronization module 304, website editor 306, website display module 308, website editor 1000, code suggestion module 1002, flowchart 200, flowchart 400, flowchart 800, step 902, and/or flowchart 1100 may be implemented as computer program code/instructions configured to be executed in one or more processors and stored in a computer readable storage medium. Alternatively, website development system 112, file transfer interface 114, website development system 300, website selection module 302, website file synchronization module 304, website editor 306, website display module 308, website editor 1000, code suggestion module 1002, flowchart 200, flowchart 400, flowchart 800, step 902, and/or flowchart 1100 may be implemented as hardware logic/electrical circuitry.

For instance, in an embodiment, one or more of website development system 112, website development system 300, website selection module 302, website file synchronization module 304, website editor 306, website display module 308, website editor 1000, code suggestion module 1002, flowchart 200, flowchart 400, flowchart 800, step 902, and/or flowchart 1100 may be implemented together in a system-on-chip (SoC). The SoC may include an integrated circuit chip that includes one or more of a processor (e.g., a central processing unit (CPU), microcontroller, microprocessor, digital signal processor (DSP), etc.), memory, one or more communication interfaces, and/or further circuits and/or embedded firmware to perform its functions.

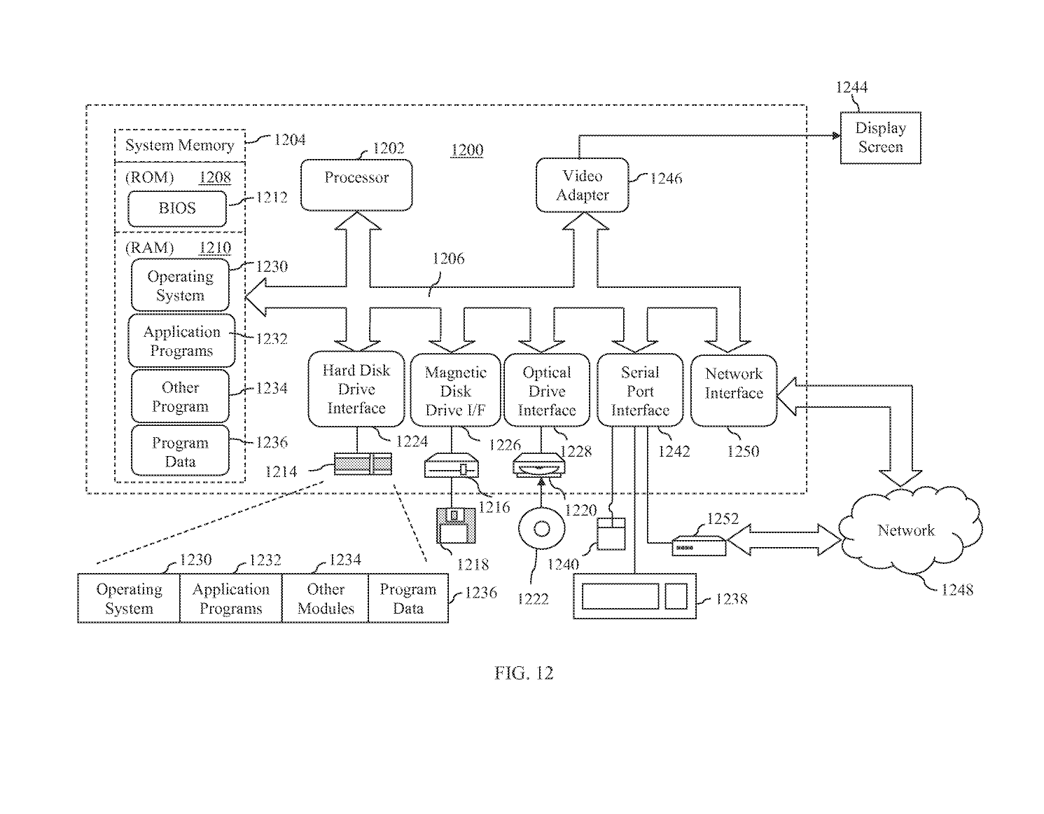

FIG. 12 depicts an exemplary implementation of a computing device 1200 in which embodiments of the present invention may be implemented. For example, computing device 102 and/or server 104 may be implemented in one or more computing devices similar to computing device 1200, including one or more features of computing device 1200 and/or alternative features. The description of computing device 1200 provided herein is provided for purposes of illustration, and is not intended to be limiting. Embodiments of the present invention may be implemented in further types of computer systems, as would be known to persons skilled in the relevant art(s).

As shown in FIG. 12, computing device 1200 includes one or more processors 1202, a system memory 1204, and a bus 1206 that couples various system components including system memory 1204 to processor 1202. Bus 1206 represents one or more of any of several types of bus structures, including a memory bus or memory controller, a peripheral bus, an accelerated graphics port, and a processor or local bus using any of a variety of bus architectures. System memory 1204 includes read only memory (ROM) 1208 and random access memory (RAM) 1210. A basic input/output system 1212 (BIOS) is stored in ROM 1208.

Computing device 1200 also has one or more of the following drives: a hard disk drive 1214 for reading from and writing to a hard disk, a magnetic disk drive 1216 for reading from or writing to a removable magnetic disk 1218, and an optical disk drive 1220 for reading from or writing to a removable optical disk 1222 such as a CD ROM, DVD ROM, or other optical media. Hard disk drive 1214, magnetic disk drive 1216, and optical disk drive 1220 are connected to bus 1206 by a hard disk drive interface 1224, a magnetic disk drive interface 1226, and an optical drive interface 1228, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, RAMs, ROMs, and the like.

A number of program modules may be stored on the hard disk, magnetic disk, optical disk, ROM, or RAM. These programs include an operating system 1230, one or more application programs 1232, other program modules 1234, and program data 1236. Application programs 1232 or program modules 1234 may include, for example, computer program logic (e.g., computer program code or instructions) for implementing website development system 112, file transfer interface 114, website development system 300, website selection module 302, website file synchronization module 304, website editor 306, website display module 308, website editor 1000, code suggestion module 1002, flowchart 200, flowchart 400, flowchart 800, step 902, and/or flowchart 1100 (including any step of flowcharts 200, 400, 800, and 1100), and/or further embodiments described herein.

A user may enter commands and information into the computing device 1200 through input devices such as keyboard 1238 and pointing device 1240. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor 1202 through a serial port interface 1242 that is coupled to bus 1206, but may be connected by other interfaces, such as a parallel port, game port, or a universal serial bus (USB).

A display screen 1244 is also connected to bus 1206 via an interface, such as a video adapter 1246. Display screen 1244 may be external to, or incorporated in computing device 1200. In addition to display screen 1244, computing device 1200 may include other peripheral output devices (not shown) such as speakers and printers.

Computing device 1200 is connected to a network 1248 (e.g., the Internet) through an adaptor or network interface 1250, a modem 1252, or other means for establishing communications over the network. Modem 1252, which may be internal or external, may be connected to bus 1206 via serial port interface 1242, as shown in FIG. 12, or may be connected to bus 1206 using another interface type, including a parallel interface.

As used herein, the terms “computer program medium,” “computer-readable medium,” and “computer-readable storage medium” are used to generally refer to media such as the hard disk associated with hard disk drive 1214, removable magnetic disk 1218, removable optical disk 1222, as well as other media such as flash memory cards, digital video disks, RAMs, ROMs, and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1232 and other program modules 1234) may be stored on the hard disk, magnetic disk, optical disk, ROM, or RAM. Such computer programs may also be received via network interface 1250, serial port interface 1242, or any other interface type. Such computer programs, when executed or loaded by an application, enable computing device 1200 to implement features of embodiments of the present invention discussed herein. Accordingly, such computer programs represent controllers of the computing device 1200.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method in a computing device for enabling a developer to edit a website, comprising:
enabling a developer to select a website for editing, the website defined by a plurality of files stored at a server, the plurality of files including files containing code;
issuing a call to download a copy of the files containing code from the server to store in a cache at the computing device in response to the developer selecting the website for editing;
enabling the developer to edit the files containing code to generate an edited version of the website, including
enabling the developer to edit a downloaded copy of a file of the files containing code in the cache when a copy of at least one other file of the files containing code has not yet been downloaded to the cache in response to the call; and
enabling the developer to display the edited version of the website.

2. The method of claim 1, further comprising:
displaying the files defining the website in a list at the computing device; and
said enabling the developer to edit the files containing code to generate an edited version of the website comprising:
enabling the developer to select a file in the list for editing.

3. The method of claim 2, wherein said enabling the developer to edit the files containing code to generate an edited version of the website further comprises:
determining that the selected file has not yet been downloaded to the cache in response to the call; and
reordering the download to prioritize downloading of the selected file over downloading one or more other files of the list.

4. The method of claim 1, further comprising:
automatically synchronizing the edited one or more files in the cache with the plurality of files stored at the server, including
automatically replacing the file of the plurality files at the server with the edited downloaded copy of the file.

5. The method of claim 1, wherein said enabling the developer to edit the files containing code to generate an edited version of the website comprises:
comparing code input by the developer to an open file in the cache to contents of at least one other file of the plurality of files in the cache to determine one or more code suggestions;
displaying the one or more code suggestions to the developer; and
enabling the developer to select a code suggestion of the displayed one or more code suggestions for inclusion in the open file.

6. The method of claim 1, wherein said issuing a call to download a copy of the plurality of files from the server to store in a cache at the computing device in response to the developer selecting the website for editing comprises:
downloading the files containing code to the cache, the at least one non-editable file not being downloaded to the cache.

7. The method of claim 1, wherein said enabling the developer to edit the files containing code to generate an edited version of the website comprises:
enabling the developer to perform a find all function when editing a file of the files containing code that searches for an input search term in all of the files containing code stored in the cache.

8. The method of claim 1, further comprising:
enabling the developer to close an application that enabled the developer to edit the files containing code to generate an edited version of the website;
enabling a developer to select the website for editing a subsequent time;
determining one or more files of the files containing code at the server that were modified subsequent to the developer closing the application; and
issuing a second call to download a copy of each of the one or more files that were determined to be modified from the server to store in the cache, any of the plurality of files at the server that were not modified subsequent to the developer closing the application not being downloaded to the cache in response to the second call.

9. A system in a computing device for enabling a developer to edit a website, comprising:
a website selection module configured to enable a developer to select a website for editing, the website defined by a plurality of files stored at a server, the plurality of files including files containing code;
a website file synchronization module configured to issue a call to download copies of the files containing code from the server to store in a cache at the computing device in response to the developer selecting the website for editing;
a website editor configured to enable the developer to edit the files containing code to generate an edited version of the website, the website editor configured to display the files defining the website in a list at the computing device, to enable the developer to select a file in the list for editing, and to enable the developer to edit a downloaded copy of the file of the files containing code in the cache when a copy of at least one other file of the files containing code has not yet been downloaded to the cache in response to the call; and
a website display module configured to enable the developer to display the edited version of the website.

10. The system of claim 9, wherein when the website file synchronization module determines that the selected file has not yet been downloaded to the cache in response to the call, the website file synchronization module is configured to reorder the download to prioritize downloading of the selected file over downloading one or more other files of the list.

11. The system of claim 9, wherein the website file synchronization module is configured to automatically synchronize the edited one or more files in the cache with the plurality of files stored at the server.

12. The system of claim 9, wherein the website editor comprises:
a code suggestion module configured to compare code input by the developer to an open file in the cache to contents of at least one other file of the plurality of files in the cache to determine one or more code suggestions, to display the one or more code suggestions to the developer, and to enable the developer to select a code suggestion of the displayed one or more code suggestions for inclusion in the open file.

13. The system of claim 9, wherein the website editor is configured to enable to be closed by the developer subsequent to generating the edited version of the website;
the website selection module is configured to enable a developer to select the website for editing a subsequent time; and
the website file synchronization module is configured determine one or more files of the files containing code at the server that were modified subsequent to the developer closing the website editor, and to generate a second call to download a copy of each of the one or more files that were determined to be modified from the server to store in the cache, any of the plurality of files at the server that were not modified subsequent to the developer closing the website editor not being downloaded to the cache in response to the second call.

14. A computer readable storage medium having computer program instructions stored in the computer readable storage medium that enable a processor to enable a developer to edit a website, the computer program instructions comprising:
first computer program instructions that enable the processor to enable a developer to select a website for editing, the website defined by a plurality of files stored at a server, the plurality of files including files containing code;
second computer program instructions that enable the processor to issue a call to download a copy of the files containing code from the server to store in a cache at the computing device in response to the developer selecting the website for editing, the at least one non-editable file not downloaded to the cache; and
third computer program instructions that enable the processor to enable the developer to edit the files containing code to generate an edited version of the website, including
computer program instructions that enable the processor to enable the developer to edit a downloaded copy of a file of the files containing code in the cache when a copy of at least one other file of the files containing code has not yet been downloaded to the cache in response to the call.

15. The computer readable storage medium of claim 14, further comprising:
computer program instructions that enable the processor to enable the developer to display the edited version of the website.

16. The computer readable storage medium of claim 14, further comprising:
computer program instructions that enable the processor to display the files defining the website in a list at the computing device; and
said third computer program instructions comprising:
computer program instructions that enable the processor to enable the developer to select a file in the list for editing.

17. The computer readable storage medium of claim 16, wherein said second computer program instructions comprise:
computer program instructions that enable the processor to determine that the selected file has not yet been downloaded to the cache in response to the call; and
computer program instructions that enable the processor to reorder the download to prioritize downloading of the selected file over downloading one or more other files of the list.

18. The computer readable storage medium of claim 14, further comprising:
computer program instructions that enable the processor to automatically synchronize the edited one or more files in the cache with the plurality of files stored at the server, including
computer program instructions that enable the processor to automatically replace the file of the plurality files at the server with the edited downloaded copy of the file.

19. The computer readable storage medium of claim 14, wherein said third computer program instructions comprise:
computer program instructions that enable the processor to compare code input by the developer to an open file in the cache to contents of at least one other file of the plurality of files in the cache to determine one or more code suggestions;
computer program instructions that enable the processor to display the one or more code suggestions to the developer; and
computer program instructions that enable the processor to enable the developer to select a code suggestion of the displayed one or more code suggestions for inclusion in the open file.

20. The computer readable storage medium of claim 14, wherein the third computer program instructions enable the processor to enable a developer to select the website for editing a subsequent time;
the second computer program instructions enable the processor to determine one or more files of the files containing code at the server that were modified subsequent to the developer closing the application; and
the second computer program instructions enable the processor to issue a second call to download a copy of each of the one or more files that were determined to be modified from the server to store in the cache, any of the plurality of files at the server that were not modified subsequent to the developer closing the application not being downloaded to the cache in response to the second call.
